(19) United States
(12) Patent Application Publication
(10) Pub. No.: US 2006/0075155 A1
(43) Pub. Date: Apr. 6, 2006

(54) Information handling system including detection of serial attached small computer systems interface ("SAS") and serial advanced technology attachment ("SATA") devices

(75) Inventors: Paul Daniel Fuller, Georgetown, TX (US); Jason Michael Lau, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/959,890

(22) Filed: Oct. 6, 2004

(51) Int. Cl. G06F 3/00

(52) U.S. Cl. 710/16

(57) ABSTRACT

It is determined whether a storage device that is coupled to a serial attached small computer systems interface (“SAS”) interface is a SAS storage device or a serial attached advanced technology attachment (“SATA”) storage device.

### BACKGROUND

The description herein relates to information handling systems having serial attached small computer systems interface (“SAS”) controllers.

As the value and use of information continue to increase, individuals and businesses seek additional ways to process and store information. One option available to users is information handling systems. An information handling system (“IHS”) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Serial attached small computer systems interface (“SAS”) and serial advanced technology attachment (“SATA”) storage devices (e.g., disk drives) are both capable of being coupled to a SAS interface (e.g., a “connector”). For example, a SAS controller with a SAS interface is capable of being coupled to either a SAS disk drive or a SATA disk drive via the same interface. Such compatibility may cause various problems such as a user undesirably or inadvertently connecting to a SAS controller, a SATA disk drive instead of a SAS disk drive, and vice versa.

What is needed is a method and an IHS without the disadvantages discussed above.

### SUMMARY

Accordingly, it is determined whether a storage device that is coupled to a serial attached small computer systems interface (“SAS”) interface is a SAS storage device or a serial attached advanced technology attachment (“SATA”) storage device.

### BRIEF DESCRIPTION OF THE DRAWINGS

FIG. 1 is a block diagram of an information handling system, according to the illustrative embodiment.

FIG. 2 is a block diagram of a storage enclosure, accordingly to the illustrative embodiment.

FIG. 3 is a block diagram illustrating an interface (e.g., connector) that is representative of one of the interfaces of FIG. 2.

FIG. 4 is a block diagram of a SAS storage device, including its interface, according to the illustrative embodiment.

FIG. 5 is a block diagram of a SATA storage device, including its interface, according to the illustrative embodiment.

### DETAILED DESCRIPTION

For purposes of this disclosure, an information handling system (“IHS”) includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer, a storage enclosure, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

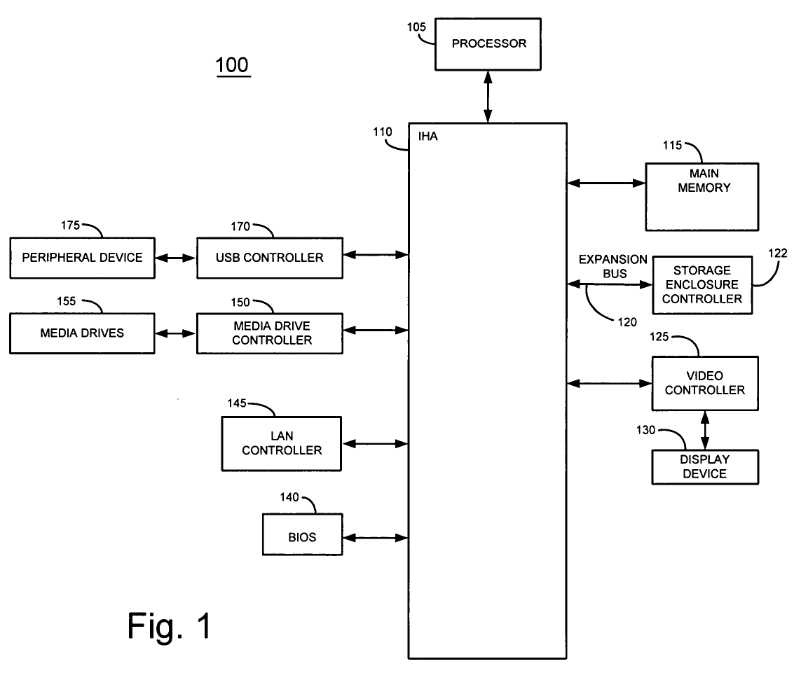

FIG. 1 is a block diagram of an IHS indicated generally at 100, according to the illustrative embodiment. The IHS 100 includes a processor 105 (e.g., an Intel Pentium series processor). An Intel Hub Architecture (IHA) chipset 110 provides the IHS 100 with graphics/memory controller hub functions and I/O functions. More specifically, the IHA chipset 110 acts as a host controller which communicates with a video controller 125 coupled thereto. A display device 130 is coupled to the video controller 125.

The chipset 110 further acts as a controller for main memory 115 which is coupled thereto. The chipset 110 also acts as an input/output (“I/O”) controller hub (ICH) which performs I/O functions. A USB controller 170 is coupled to chipset 110 so that devices such as a peripheral device 175 can be connected to the chipset 110 and the processor 105. Examples of the peripheral device 175 include printers, cameras, scanners, audio players, and other suitable devices. Although the peripheral device 175 communicates with the IHS 100 via a USB interface in the illustrative embodiment, in other embodiments, the peripheral device 175 communicates with the IHS 100 via another type of interface such as serial, parallel, FireWire, and/or any other suitable connection interface. A system basic input-output system (“BIOS”) 140 is coupled to chipset 110 as shown. The BIOS 140 is stored in CMOS or FLASH memory so that it is nonvolatile.

A local area network (LAN) controller 145, alternatively called a network interface controller (NIC), is coupled to the chipset 110 to facilitate connection of the IHS 100 to other IHSs. A media driver controller 150 is coupled to chipset 110 so that devices such as media drives 155 can be connected to the chipset 110 and the processor 105. Examples of the media devices 155 capable of being coupled to the media controller 150 include CD-ROM drives, DVD drives, hard disk drives and other fixed or removable media drives. An expansion bus 120, such as a peripheral component interconnect (PCI) bus, PCI express bus is coupled to the chipset 110 as shown. Via the expansion bus 120, a storage enclosure controller (e.g., a host bus adapter) 122 is also coupled to the chipset 110.

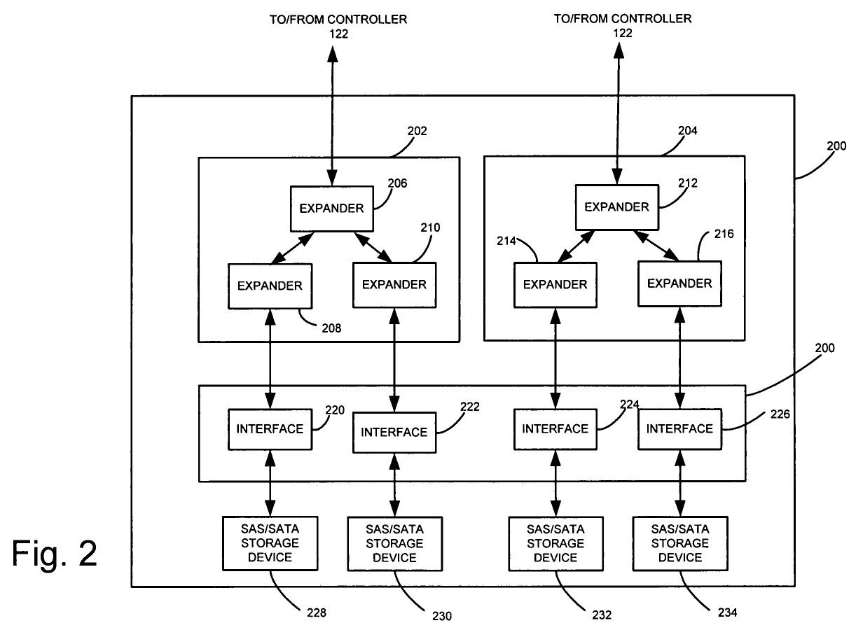

In the illustrative embodiment, the IHS 100 is a server. For providing the IHS 100 with storage capacity, a storage enclosure is coupled to the IHS 100 via the controller 122. Accordingly, FIG. 2 is a block diagram of a storage enclosure 200, accordingly to the illustrative embodiment.

The storage enclosure 200 includes controller cards 202 and 204. Each of the controller cards 202 and 204 includes expanders. For example, the controller card 202 includes expanders 206, 208, 210, and the controller 204 includes expanders 212, 214, and 216. Via one or more of the expanders 206, 208, 210, 212, 214, or 216, one or more storage devices (e.g., SAS drives or SATA drives) are capable of being coupled to the controller card 202.

Within each of the controller cards 202 and 204, one or more of the expanders are capable of operating as an interface between the controller 122 and other expanders. For example, within the controller card 202, the expander 206 is an interface between the controller 122 and the other expanders 208 and 210.

The enclosure 200 also includes a back pane 218, which includes interfaces 220, 222, 224, and 226. Via the interfaces 220, 222, 224, and 226, one or more SAS drives and/or SATA drives are capable of being coupled to one or more of the expanders included by the controller cards 202 and 204. Accordingly, the enclosure 200 includes SAS/SATA storage devices 228, 230, 232, and 234, which are respectively coupled to the expanders 208, 220, 214, and 216 via the interfaces 220, 222, 224, and 226.

Although FIG. 2 depicts the two controller cards 202 and 204, the enclosure 200 may include additional controller cards which are substantially identical to the controller cards 202 and 204, or include fewer controller cards. Similarly, although each of the controller cards is depicted as including three expanders, each of the controller card may include additional expanders that are substantially identical to the expanders depicted in FIG. 2, or fewer expanders.

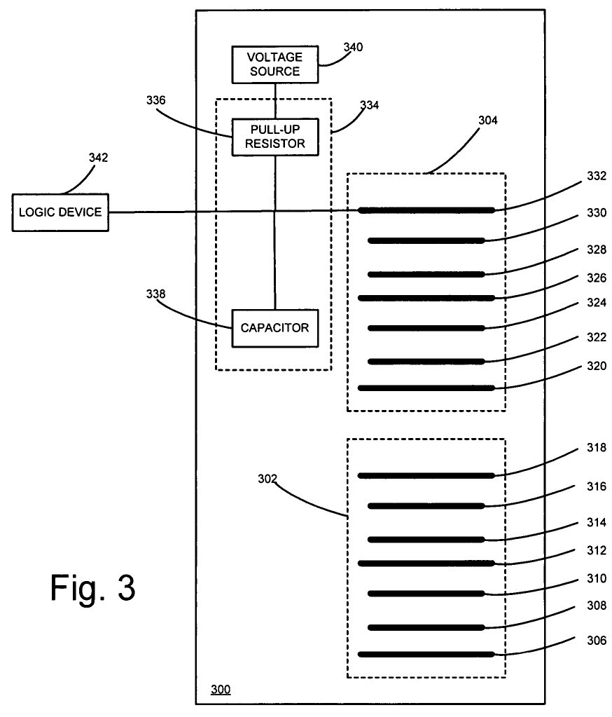

FIG. 3 is a block diagram illustrating an interface (e.g., connector), indicated at 300, that is representative of one of the interfaces 220, 222, 224, or 226 of FIG. 2. The interface 300 is a SAS interface, via which, a SAS storage device or a SATA storage device is capable of being coupled to an expander (e.g., one of the expanders of FIG. 2) or another suitable device such as a SAS controller.

The interface 300 includes a first port (e.g., port A) 302 and a second port (e.g., port B) 304. Each of the ports 302 and 304 includes one or more transmit (“TX”) wires (e.g., “pins”), receive (“RX”) wires, and ground (“GND”) wires. For example, the port 302 includes GND pins 306, 312, and 318. The port 302 also includes TX pins 308 and 310. Moreover, the port 302 includes RX pins 314 and 316.

Similar to the port 302, the port 304 includes GND pins 320, 326, and 332, TX pins 322 and 324, and RX pins 328 and 330. The GND pin 332 is coupled to a detection circuit, indicated generally at 334, that detects whether a SAS storage device or a SATA storage device is coupled to the interface 300. The detection circuit 334 includes a resistor (e.g., a “pull-up” resistor) 336. In the illustrative embodiment, the pull-up resistor 336 is an approximately 4.7 kilo-ohm pull-up resistor. The detection circuit 334 also includes a capacitor 338. In one example, the capacitor 338 is an approximately 1 uF capacitor. Each of the pull-up resistor 336 and the capacitor 338 is coupled to the GND pin 332.

The detection circuit 334 is coupled to a voltage source 340 via the pull up resistor 334. In the illustrative embodiment, voltage supplied by the voltage source 340 is approximately 5 volts. Also, the detection circuit 334 is coupled to a logic device 342 (e.g., a processor or a complex programmable logic device (“CPLD”), a field programmable gate array (“FPGA”) or a comparator circuit). The logic device 342 is also coupled to the GND pin 332. In at least one alternative embodiment, the detection circuit 336 includes the logic device 342.

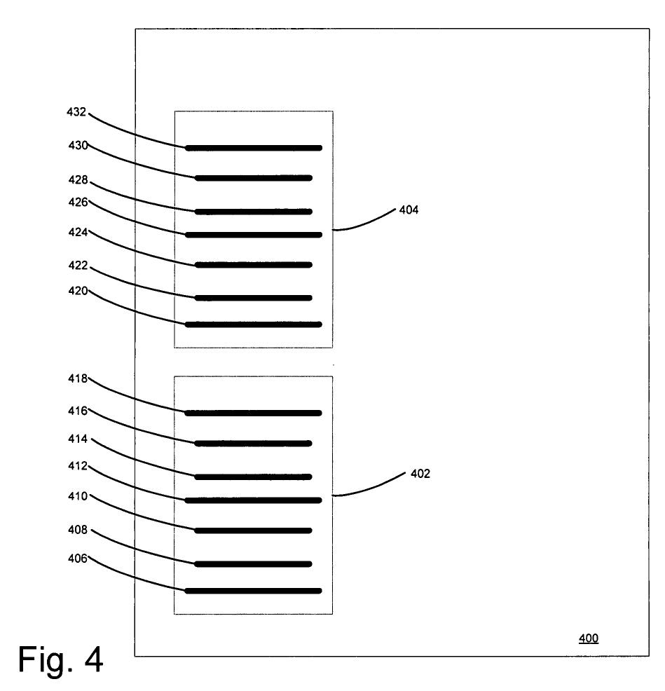

FIG. 4 is a block diagram of a SAS storage device 400, including its interface, according to the illustrative embodiment. The SAS storage device 400 is capable of being coupled to an expander (e.g., one of the expanders of FIG. 2) via an interface, such as the interface 300 of FIG. 3. For example, the storage device 400 includes a first port (e.g., port A) 402 and a second port (e.g., port B) 404, each of which is respectively capable of being coupled the port 302 and the port 304 of FIG. 3.

Each of the ports 402 and 404 includes one or more GND, TX, and RX pins. For example, the port 402 includes GND pins 406, 412, and 418, TX pins 408 and 410, and RX pins 414 and 416. The port 404 includes GND pins 420, 426, and 432, TX pins 422 and 424, and RX pins 428 and 430.

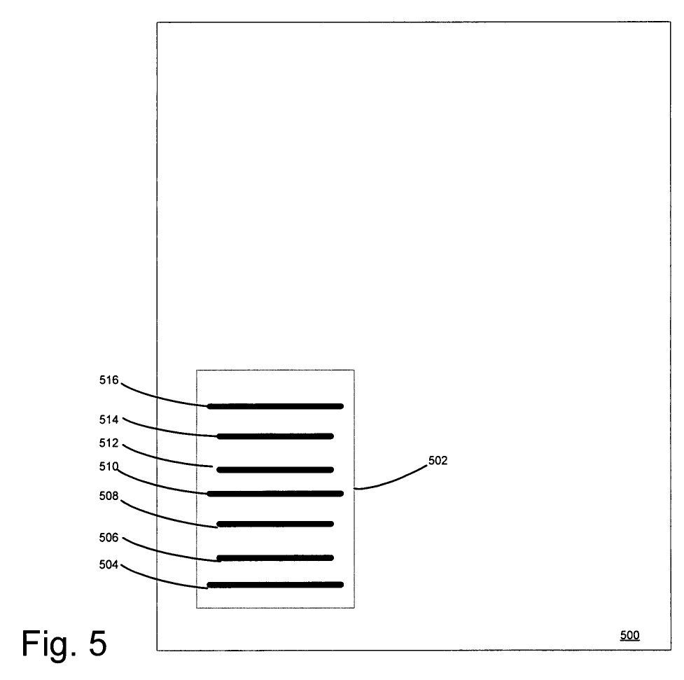

FIG. 5 is a block diagram of a SATA storage device 500, including its interface, according to the illustrative embodiment. Similar to the SAS storage device 400, the SATA storage device 500 is capable of being coupled to an expander via an interface, such as the interface 300 of FIG. 3. However, the SATA storage device 500 couples to the interface 300 via one of the ports 302 and 304. In the illustrative embodiment, the SATA storage device 500 couples to the interface 300 via the port 302 (e.g., port A). Accordingly, the SATA storage device 500 includes a port 502, which is capable of being coupled to the port 302 of FIG. 3. Similar to the port 402 of FIG. 4, the port 302 includes GND pins 504, 510, and 516, TX pins 506 and 508, and RX pins 512 and 514.

As discussed above, the detection circuit 334 determines (e.g., detects) whether a SAS storage device or a SATA storage device is coupled to the interface 300. In one example, the detection circuit 334 makes such determination by determining whether an SAS storage device is coupled to the interface 300. For example, if the detection circuit 334 determines that a SAS storage device is not coupled to the interface 300, the detection circuit 334 determines that a SATA storage device is coupled to the interface 300.

In one embodiment, the detection circuit 334 determines whether a storage device that is coupled to the interface 300 is a SAS storage device or a SATA storage device by determining whether the storage device includes two ports (e.g., ports A and B). As shown in FIGS. 4 and 5, the SAS storage device 400 includes two ports (e.g., the ports 402 and 404), and the SATA storage device 500 includes one port (e.g., the port 502).

In more detail, referring again to FIG. 3, the pull-up resistor and the voltage source 340 are coupled to the GND pin 332. When a SATA storage device such as the SATA storage device 500 is coupled to the interface 300, the GND pin 332 is uncoupled because the SATA storage device 500 does not have a port that is associated with the port 304. Accordingly, in response to the GND pin 332 being uncoupled to a GND pin of a SAS storage device (e.g., the SAS storage device 400 of FIG. 4), the GND pin 332's signal is approximately the voltage (e.g., 5 volts) of the voltage source 340. In such situation, the pull-up resistor “pulls’ the GND pin 332 signal up to the voltage supplied by the voltage source 340. Also, such signal indicates a first logic (e.g., logic 1). Moreover, such signal indicates (e.g., to the logic device 342) that a storage device that is coupled to the interface 300 is a SATA storage device. The logic device 342 receives such signal of the GND pin 332.

Alternatively, in response to a SAS storage device, such as the SAS storage device 400, being coupled to the interface 300, the GND pin 332 is also coupled to the GND pin 432. In such situation, the signal on the GND pin 332 is pulled down to 0 volts indicating a second logic signal (e.g., logic 0). Such signal indicates (e.g., to the logic device 342) that a storage device that is coupled to the interface 300 is a SAS storage device. The logic device 342 receives such signal of the GND pin 332.

Referring again to FIG. 3, the capacitor 338 is coupled to the detection circuit 334 (and the GND pin 332) so that there is a relatively low impendence alternating current (“AC”) return path to the GND pin 332. Accordingly, the capacitor 338 reduces the detection circuit 334's adverse effect on signal clarity of the interface 300.

Although illustrative embodiments have been shown and described, a wide range of modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

What is claimed is:

1. A method comprising:
determining whether a storage device that is coupled to a serial attached small computer systems interface (“SAS”) interface is a SAS storage device or a serial attached advanced technology attachment (“SATA”) storage device.

2. The method of claim 1, wherein the determining includes:
determining whether the storage device includes a first port and a second port;
in response to determining that the storage device includes a first port and a second port, determining that the storage device is a SAS storage device; and
in response to determining that the storage device includes a first port but not a second port, determining that the storage device is a SATA storage device.

3. The method of claim 2, wherein the SAS interface includes a first port and a second port and determining whether the storage device includes a second port includes:
determining whether a pin included by the SAS interface's second port is uncoupled.

4. The method of claim 3, wherein the pin is a ground (“GND”) pin.

5. The method of claim 4, wherein determining whether the GND pin is uncoupled is performed by a detection circuit.

6. The method of claim 5, wherein the detection circuit includes a pull-up resistor.

7. The method of claim 6, wherein the pull-up resistor is an approximately 4.7 kilo-ohm pull-up resistor.

8. The method of claim 5, wherein the detection circuit includes a capacitor.

9. The method of claim 8, wherein the capacitor is an approximately 1 uF capacitor.

10. The method of claim 5, wherein the detection circuit is coupled to a logic device.

11. The method of claim 1, wherein the interface is included by a back-pane of a storage enclosure.

12. An information handling system (“IHS”) comprising:
a processor;
a serial attached small computer systems interface (“SAS”) controller, including an interface, coupled to the processor; and
a detection circuit for determining whether a storage device that is coupled to the interface is a SAS storage device or a serial attached advanced technology attachment (“SATA”) storage device.

13. The IHS of claim 12, wherein the detection circuit is for: determining whether the storage device includes a first port and a second port; in response to determining that the storage device includes a first port and a second port, determining that the storage device is a SAS storage device; and in response to determining that the storage device includes a first port but not a second port, determining that the storage device is a SATA storage device.

14. The IHS of claim 13, wherein the interface includes a first port and a second port and determining whether the storage device includes a second port includes:
determining whether a pin included by the interface's second port is uncoupled.

15. The IHS of claim 14, wherein the pin is a ground (“GND”) pin.

16. The IHS of claim 12, wherein the detection circuit includes a pull-up resistor.

17. The IHS of claim 16, wherein the pull-up resistor is an approximately 4.7 kilo-ohm pull-up resistor.

18. The IHS of claim 12, wherein the detection circuit includes a capacitor.

19. The IHS of claim 18, wherein the capacitor is an approximately 1 uF capacitor.

20. The IHS of claim 12, and comprising:
a logic device coupled to the detection circuit.

21. The IHS of claim 20, wherein the logic device is a complex programmable logic device (“CPLD”).

22. The IHS of claim 20, wherein the logic device is a field programmable gate array (“FPGA”).

23. The IHS of claim 20, wherein the logic device is a comparator circuit.
